(19) United States
(12) Patent Application Publication
(10) Pub. No.: US 2011/0001656 A1
(43) Pub. Date: Jan. 6, 2011

(54) RADAR SYSTEM AND SIGNAL PROCESSING METHOD FOR RADAR SYSTEM

(75) Inventors: Makoto NAKAI, Aichi-gun (JP); Masaru Ogawa, Seto-shi (JP); Tomoya Kawasaki, Toyota-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/824,616

(22) Filed: Jun. 28, 2010

(30) Foreign Application Priority Data
Jul. 1, 2009 (JP) 2009-156482

(51) Int. Cl. G01S 13/42; G01S 13/58; G01S 13/08

(52) U.S. Cl. 342/99; 342/104; 342/145; 342/147; 342/108

(57) ABSTRACT

A radar system includes: a transmission antenna outputting transmission signals having multiple frequencies; multiple reception antennas receiving reflected waves of the transmission signals, reflected from an object; a mixer mixing the transmission signals with reception signals received by the reception antennas to generate beat signals; and a signal processing unit detecting Doppler frequency by analyzing frequencies of the beat signals, detecting phase information of the Doppler frequency for each of combinations of the reception antennas and the transmission signal frequencies, constructing a matrix having the pieces of phase information arranged in a predetermined order with respect to the reception antennas and the frequencies of the transmission signals, obtaining a correlation matrix from the matrix and its complex conjugate transposed matrix, and estimating at least one of a distance, direction and relative velocity of the object based on the correlation matrix.

### INCORPORATION BY REFERENCE

The disclosure of Japanese Patent Application No. 2009-156482 filed on Jul. 1, 2009 including the specification, drawings and abstract is incorporated herein by reference in its entirety.

### BACKGROUND OF THE INVENTION

1. Field of the Invention

The invention relates to a CW radar system that uses a plurality of reception antennas, and a signal processing method for the radar system.

2. Description of the Related Art

In order to detect a distance to a stationary or moving object, a direction to the object and a moving velocity of the object, various radar systems have been developed.

For example, Japanese Patent Application Publication No. 2008-145425 (JP-A-2008-145425) describes a radar system that outputs transmission signals having three or more different frequencies from an oscillator, receives signals reflected from a target, mixes the reception signals with the transmission signals by a mixer to generate beat signals, detects Doppler frequency signals from the beat signals through fast Fourier transform (FFT), or the like, and then obtains a distance to the target on the basis of complex signal components of the Doppler frequency signals of the respective transmission signals.

In the CW radar system, reflected signals from the target in correspondence with the transmission signals having a plurality of frequencies are received by a plurality of reception antennas and are analyzed. Then, in the CW radar system, in order to obtain distance information to the target in high resolution, pieces of phase information obtained from the respective reception antennas (reception channels) are used to estimate a distance to the target. In this estimation, a correlation matrix is calculated using phase information for each reception channel. Therefore, as the number of reception channels increases, a computational load increases.

In addition, when there is only one target, it is obvious that beat signals obtained through the respective reception channels are signals from the same target, so it is possible to accurately estimate a direction to the target from phase differences between the reception channels. However, when there are a plurality of targets having different relative velocities, beat signals of the number of targets are detected through each reception channel, and it is necessary to associate (pair) the beat signals among the reception channels.

For example, when there are two targets having different relative velocities, two beat signals are detected through each of the two reception channels. Where the beat signals detected through a reception channel 1 are L1 and L2, and the beat signals detected through a reception channel 2 are R1 and R2, there are two combination patterns of the beat signals between the reception channels 1 and 2, that is, (1) (L1, R1) and (L2, R2) or (2) (L1, R2) and (L2, R1). Here, if an erroneous combination is made, the directions to the targets are also erroneously estimated. In addition, when the number of targets increases, a processing load for associating beat signals increases.

### SUMMARY OF THE INVENTION

A first aspect of the invention provides a radar system. The radar system includes: a transmission antenna that outputs transmission signals having a plurality of frequencies as transmission waves; a plurality of reception antennas that receive reflected waves of the transmission signals, reflected from an object; a mixer that mixes the transmission signals with reception signals received by the reception antennas to generate beat signals of the reception signals received by the respective reception antennas for each of the transmission signals; and a signal processing unit that detects Doppler frequency by analyzing frequencies of the beat signals, that detects phase information of the Doppler frequency for each of combinations of the reception antennas and the frequencies of the transmission signals, that constructs a matrix, in which the pieces of phase information are arranged in a predetermined order with respect to the reception antennas and the frequencies of the transmission signals, that obtains a correlation matrix from the matrix and a complex conjugate transposed matrix of the matrix, and that estimates at least one of a distance to the object, a direction to the object and a relative velocity of the object on the basis of the correlation matrix.

Here, the signal processing unit may estimate the at least one of the distance to the object, the direction to the object and the relative velocity of the object after the correlation matrix has been averaged by at least one of forward-backward averaging and spatial moving average.

A second aspect of the invention provides a signal processing method for a radar system that includes a transmission antenna that outputs transmission signals having a plurality of frequencies as transmission waves and a plurality of reception antennas that receive reflected waves of the transmission signals, reflected from an object. The signal processing method includes: mixing the transmission signals with reception signals received by the reception antennas to generate beat signals of the reception signals received by the respective reception antennas for each of the transmission signals having the plurality of frequencies; detecting Doppler frequency by analyzing frequencies of the beat signals; detecting phase information of the Doppler frequency for each of combinations of the reception antennas and the frequencies of the transmission signals; constructing a matrix, in which the pieces of phase information are arranged in a predetermined order with respect to the reception antennas and the frequencies of the transmission signals; obtaining a correlation matrix from the matrix and a complex conjugate transposed matrix of the matrix; and estimating at least one of a distance to the object, a direction to the object and a relative velocity of the object on the basis of the correlation matrix.

According to the aspects of the invention, it is possible to reduce processing load on the radar system.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a view that shows the configuration of a radar system according to an embodiment of the invention;

FIG. 2 is a graph that shows changes in frequency of transmission signals according to the embodiment of the invention; and

FIG. 3 is a view that shows an example of analyzing frequencies of reception signals according to the embodiment of the invention.

### DETAILED DESCRIPTION OF EMBODIMENTS

### System Configuration

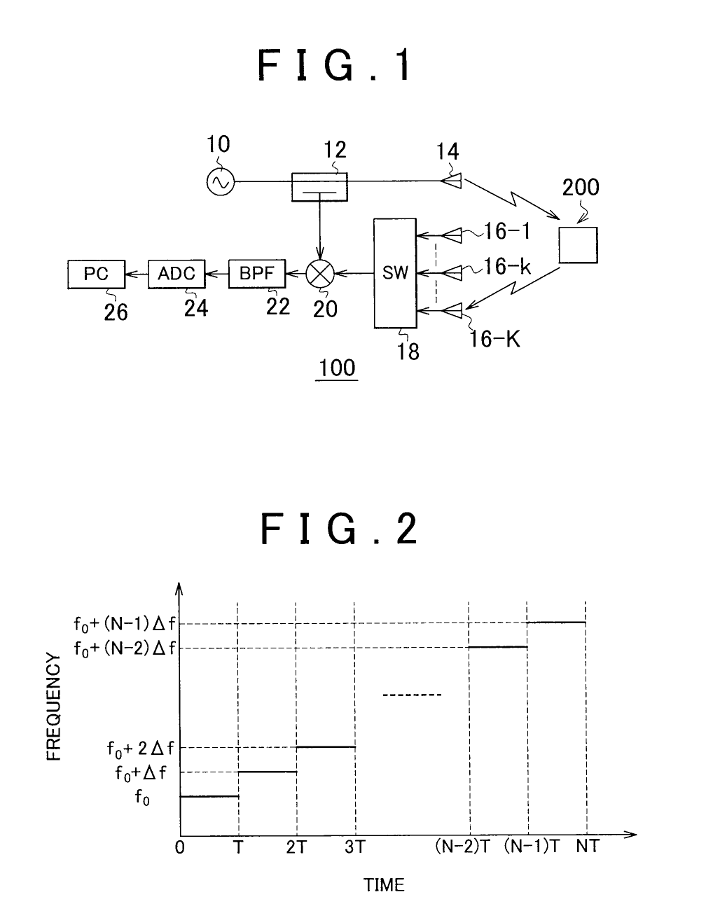

As shown in FIG. 1, a radar system 100 according to an embodiment of the invention includes an oscillator 10, a directional coupler 12, a transmission antenna 14, reception antennas 16-k (k is an integer larger than or equal to 2), a switch 18, a mixer 20, a band pass filter (BPF) 22, an analog/digital converter (ADC) 24 and a signal processing unit 26.

The oscillator 10 generates and outputs transmission signals. The transmission signals are radiated from the transmission antenna 14 as transmission waves. The oscillator 10 is able to change the oscillatory frequency. In the present embodiment, the oscillator 10 generates and outputs N types (where N is 2 or above) of continuous waves respectively having a fundamental frequency f₀ to a frequency f₀+(N−1)Δf at a predetermined frequency interval Δf. When N is 3, the oscillator 10 outputs transmission waves respectively having frequencies f₀, f₀+Δf and f₀+2Δf.

The directional coupler 12 demultiplexes the transmission signals output from the oscillator 10, and outputs the demultiplexed transmission signals to both the transmission antenna 14 and the mixer 20. The transmission antenna 14 outputs the transmission signals demultiplexed by the directional coupler 12 into space in a radiation pattern corresponding to the antenna characteristic. As shown in FIG. 2, transmission waves having frequencies of the fundamental frequency f₀ to the frequency f₀+(N−1)Δf are sequentially and repeatedly transmitted from the transmission antenna 14 at a period of time T.

The reception antennas 16-k each receive radio waves in accordance with the antenna characteristics from space. At least two or more reception antennas 16-k are provided (k is an integer larger than or equal to 2). In the present embodiment, K reception antennas 16-1 to 16-K are provided. The reception antennas 16-k are spaced apart from each other. A reception signal received by each reception antenna 16-k includes components of reflected waves that a target 200 reflects the transmission signals radiated from the transmission antenna 14. The frequencies of reflected waves shift from the frequencies of the transmission signals by a Doppler frequency in accordance with a relative velocity between the radar system 100 and the target 200. Hereinafter, the reception antennas 16-1 to 16-K may be expressed as reception channels ch1 to chK.

The switch 18 exclusively switches among reception signals received by the respective reception antennas 16-1 to 16-K, and then outputs any one of the reception signals to the mixer 20. By so doing, the reception signals received by the respective reception antennas 16-1 to 16-K are sequentially output from the switch 18. That is, transmission waves having frequencies of the fundamental frequency f₀ to the frequency f₀+(N−1)Δf are sequentially radiated, signals containing components of reflected waves reflected by the target 200 are received by the reception antennas 16-1 to 16-K, and then a reception signal received by one of the reception antennas 16-1 to 16-K, selected by the switch 18, is sequentially output to the mixer 20.

The mixer 20 mixes the transmission signal output from the directional coupler 12 with any one of the reception signals of the reception channels ch1 to chK, output from the switch 18, and outputs the mixed signal to the BPF 22. The signal output from the mixer 20 contains a beat signal having a frequency corresponding to a difference between the frequency of the transmission signal and the frequency of the reception signal. That is, when there is a relative velocity between the target 200 and the radar system 100, there occurs a frequency shift due to Doppler effect. This causes a difference in frequency between the transmission signal and the reception signal. A signal having a frequency corresponding to this difference is output as a beat signal.

The BPF 22 removes an unnecessary signal, other than a component of a beat signal that indicates a frequency shift due to Doppler effect, from a signal generated by the mixer 20, and then outputs the resultant signal to the ADC 24. The ADC 24 converts the signal output from the BPF 22 from an analog signal into a digital signal and outputs the converted signal to the signal processing unit 26.

The signal processing unit 26 receives an output signal from the ADC 24, and then estimates, for example, a distance from the radar system 100 to the target 200, a direction from the radar system 100 to the target 200 and a relative velocity between the radar system 100 and the target 200 on the basis of the output signal. The signal processing unit 26 may be implemented by executing a program, which executes the following arithmetic processing, in a general computer provided with a CPU, a memory, an input/output device, and the like. Alternatively, the signal processing unit 26 may be formed of a logic circuit that executes the following arithmetic processing.

Note that, in the present embodiment, a signal digitized by the ADC 24 is processed; instead, it is also applicable that the signal processing unit 26 is formed of an analog circuit and then an analog signal is directly processed.

### Signal Processing

Hereinafter, signal processing executed by the radar system 100 will be described. The following process will be executed by the signal processing unit 26. Note that there may be a plurality of targets 200 and it is assumed that the location and velocity of each target 200 do not change throughout the observing time.

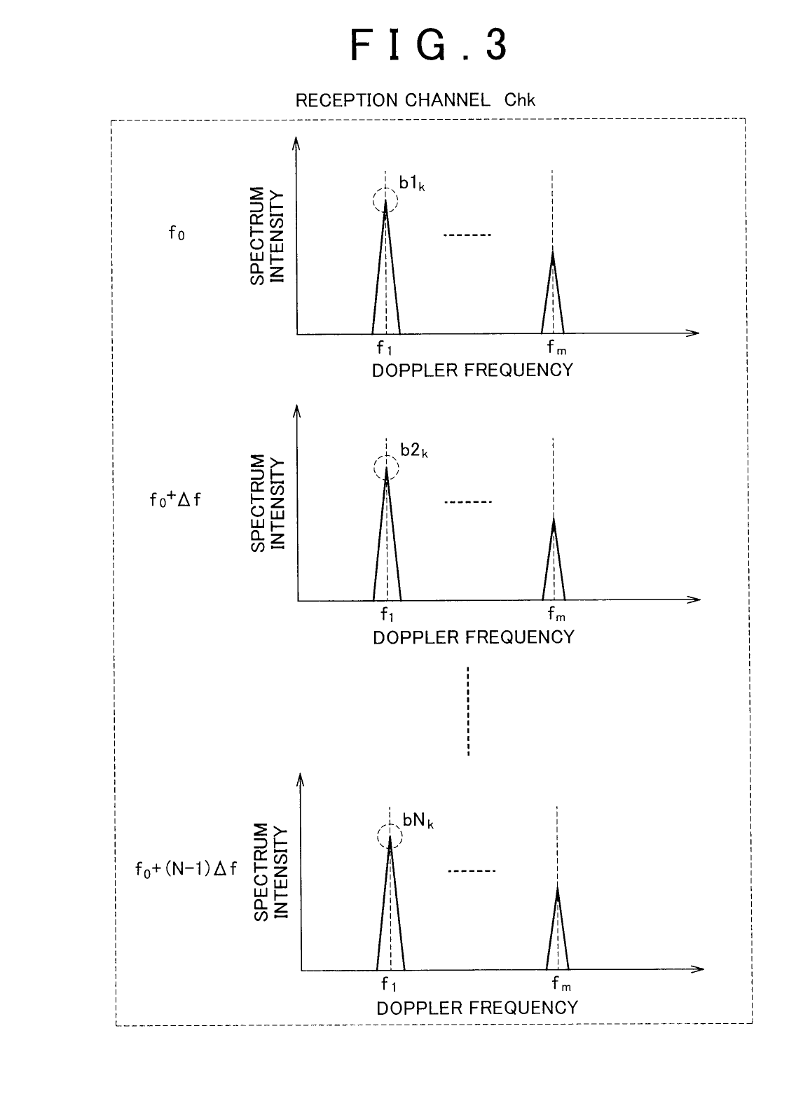

The signal processing unit 26 obtains a frequency spectrum on the basis of a signal received from the ADC 24 through fast Fourier transform, or the like. FIG. 3 shows an example in which, while the transmission signals are being transmitted, frequency spectra of beat signals generated by the mixer 20 for reception signals of the reception antennas 16-k (reception channels chk) that have received reflected waves from the targets 200 are obtained. Here, the transmission signals respectively having N (where N is 2 or above) types of frequencies of the fundamental frequency f₀ to the frequency f₀+(N−1)Δf at the frequency interval Δf are transmitted. When there are a plurality of targets 200 having different velocities, respective reflected waves have different Doppler frequencies with respect to the radar system 100, so signals of Doppler frequencies for respective velocities appear. In addition, for reflected waves of the targets 200 having no relative velocities with respect to the radar system 100, the outputs of the mixer 20 are direct-current components and then the direct-current components are removed by the BPF 22.

In the example of FIG. 3, for respective transmission signals of the fundamental frequency f₀ to the frequency f₀+(N−1)Δf, Doppler frequencies f₁ to fₘ generated on the basis of the relative velocities between the targets 200 and the radar system 100 each have a peak. As shown in FIG. 3, the Doppler frequencies f₁ to fₘ, change in proportion to not only the relative velocities between the targets 200 and the radar system 100 but also the frequencies f₀ to f₀+(N−1)Δf of the transmission signals. For example, in 76 GHz millimeter wave band, the Doppler frequency only changes by 1.3% even when the frequency changes by 1 GHz. Thus, differences in frequency between the transmission signals almost do not influence the Doppler frequencies f₁ to fₘ.

The following analysis is applied to each of the thus obtained Doppler frequencies f₁ to fₘ, and then the distances, directions and relative velocities to the targets 200 corresponding to the respective Doppler frequencies f₁ to fₘ, are estimated.

First, a complex signal component (phase information) of the spectrum of each Doppler frequency fⱼ (j is an integer ranging from 1 to m and specifies the Doppler frequency) is detected for each of combinations of the reception antennas 16-1 to 16-K (reception channels ch1 to chK) and the frequencies f₀ to f₀+(N−1)Δf of the transmission signals. Then, the complex signal components (a pieces of phase information) of the spectra of the respective Doppler frequencies f₁ are arranged in predetermined orders with respect to the reception antennas 16-1 to 16-K (reception channels ch1 to chK) and the frequencies f₀ to f₀+(N−1)Δf of the transmission signals to construct a matrix Bⱼ.

The predetermined order with respect to the reception antennas 16-1 to 16-K (reception channels ch1 to chK) are desirably an order in which, for example, the switch 18 switches among the reception antennas 16-1 to 16-K. More specifically, the predetermined order is desirably the order of the reception antenna 16-1, the reception antenna 16-2, . . . , the reception antenna 16-K. In addition, the predetermined order with respect to the frequencies f₀ to f₀+(N−1)Δf of the transmission signals is desirably an order in which, for example, the oscillator 10 generates the frequencies of the transmission signals. More specifically, the predetermined order is desirably the order of the frequency f₀, the frequency f₀+Δf, . . . , the frequency f₀+(N−1)Δf. However, the predetermined order is not limited to the above; it is only necessary that the respective orders in each row and each column of the matrix Bⱼ are kept unchanged.

When the above predetermined orders are applied, as shown in the mathematical expression (1), an element bₙₖ of the matrix Bⱼ is a complex signal component (phase information) of the Doppler frequency fⱼ in the frequency spectrum obtained by analyzing the reception signal received by the reception antenna 16-k (reception channel chk) while the transmission signal having the frequency f₀+(n−1)Δf is being transmitted. That is, n is an integer ranging from 1 to N for specifying the frequency f₀+(n−1)Δf of the transmission signal. In addition, k is an integer ranging from 1 to K for specifying the reception antenna 16-k (reception channel chk).

$${B}_{j} = ( \begin{matrix}{b}_{11} & {b}_{12} & Λ & {b}_{1 k} & Λ & {b}_{1 K} \\ {b}_{21} & ⋱ & Λ & {b}_{2 k} & Λ & {b}_{2 K} \\ ⋮ & & ⋱ & & & ⋮ \\ {b}_{n 1} & & & ⋱ & & ⋮ \\ ⋮ & & & & ⋱ & ⋮ \\ {b}_{N 1} & & Λ & & & {b}_{NK}\end{matrix} ) \qquad ( 1 )$$

For example, when N and K each are 3, the matrix B₁ corresponding to the Doppler frequency f₁ has three rows and three columns as shown in the mathematical expression (2). The element b₁₁ is a complex signal component (phase information) of the Doppler frequency f₁ in the frequency spectrum obtained by analyzing the reception signal received by the reception antenna 16-1 (reception channel ch1) while the transmission signal having the frequency f₀ is being transmitted. In addition, the element b₁₂ is a complex signal component (phase information) of the Doppler frequency f₁ in the frequency spectrum obtained by analyzing the reception signal received by the reception antenna 16-2 (reception channel ch2) while the transmission signal having the frequency f₀ is being transmitted. In addition, the element b₂₁ is a complex signal component (phase information) of the Doppler frequency f₁ in the frequency spectrum obtained by analyzing the reception signal received by the reception antenna 16-1 (reception channel ch1) while the transmission signal having the frequency f₀+Δf is being transmitted. The other elements are also similar to the above elements.

$${B}_{j} = ( \begin{matrix}{b}_{11} & {b}_{12} & {b}_{13} \\ {b}_{21} & {b}_{22} & {b}_{23} \\ {b}_{31} & {b}_{32} & {b}_{33}\end{matrix} ) \qquad ( 2 )$$

In the matrix Bⱼ, the element bₙₖ of the column vector, which corresponds to the reception antenna 16-k (reception channel chk), indicates a complex signal component (phase information) of the Doppler frequency fⱼ in each of the frequencies f₀ to f₀+(N−1)Δf of the transmission signals. Thus, the phase differences between the elements bₙₖ of the column vector occur because of the frequencies f₀ to f₀+(N−1)Δf of the transmission signals, and do not depend on the location of the reception antenna 16-k. In addition, phase differences due to optical path differences between the reception antennas 16-1 to 16-K and each target 200 depend on the locations of the reception antennas 16-1 to 16-K. Thus, the phase differences between the elements bₙₚ of the column vector with respect to a selected reception antenna 16-p (p is any one of integers ranging from 1 to K) is equal to the phase differences between the elements b_{nq} of the column vector with respect to another reception antenna 16-q (q is any one of integers ranging from 1 to K other than p).

Where the phase differences between the elements of the column vector obtained from a selected reception antenna are denoted by a reference vector Cⱼ and the phase differences due to optical path differences caused by the locations of the reception antennas are denoted by a vector Dⱼ the matrix Bⱼ may be expressed as Cⱼ×Dⱼ from the above described characteristic.

Then, a correlation matrix Rxxⱼ for the matrix Bⱼ may be expressed as the mathematical expression (3). Note that the matrix Bⱼ^{H}, the vector Cⱼ^{H} and the vector Dⱼ^{H} respectively denote complex conjugate transposed matrices (vectors) of the matrix Bⱼ, reference vector Cⱼ and vector Dⱼ.

Rxx_{J}=B_{J}×B_{J}^{H}=C_{J}×D_{J}×Dⱼ^{H}×C_{J}^{H} (3)

Here, Dⱼ×Dⱼ^{H} is a constant αⱼ, so the mathematical expression (3) may be further transformed into the mathematical expression (4).

Rxx_{J}=B_{J}×B_{J}^{H}=α_{J}×C_{J}×Cⱼ^{H} (4)

The mathematical expression (4) indicates that a mathematical expression for obtaining the correlation matrix Rxxⱼ is the same as a mathematical expression for obtaining a correlation matrix using the column vector of each reception antenna 16-k (reception channel chk). However, the correlation matrix Rxxⱼ contains complex signal components (phase information) of the Doppler frequencies f₁ obtained by all the reception antennas 16-1 to 16-K (all the reception channels ch1 to chK), so the S/N ratio of a signal spectrum obtained thereafter for the correlation matrix Rxxⱼ is higher than that of the correlation matrix obtained for each reception antenna 16-k (reception channel chk).

The thus obtained correlation matrix Rxxⱼ is utilized to estimate information about each target 200. A high-resolution estimation method, such as the MUSIC method, the ESPIRIT method and the Capon method, may be desirably employed.

Hereinafter, a distance estimation method using the Capon method will be described as an example. In the Capon method, a mathematical expression for calculating a spectrum amplitude is expressed as the mathematical expression (5). Here, a(r) is a mode vector that depends on a distance r, for which a spectrum is obtained, and the frequencies f₀ to f₀+(N−1)Δf of the transmission signals, and a(r)^{H} is a complex conjugate transposed matrix of a(r). However, the elements of a(r) are arranged in the order of the frequencies of the matrix Bⱼ.

$$Pw ( r ) = \frac{1}{{a}^{11} ( r ) {Rxx}_{j}^{- 1} a ( r )} a ( r ) = ( \begin{matrix}{e}^{j2π \frac{2 r}{c} {f}_{0}} \\ {e}^{j2π \frac{2 r}{c} ( {f}_{0} + Δ f )} \\ M \\ {e}^{j2π \frac{2 r}{c} ( {f}_{0} + ( N - 1 ) Δ f )}\end{matrix} ) \qquad ( 5 )$$

The mathematical expression (5) is used while changing the distance r at a selected distance interval to obtain power Pw(r), and then the distance r at which the power Pw(r) indicates a peak is estimated as the distance to the target 200.

The above process is carried out for each of the Doppler frequencies f₁ to fₘ to thereby make it possible to estimate the distance and direction to the target 200, and the relative velocity of the target 200, which cause the peak of the spectrum to be formed for each of the Doppler frequencies f₁ to fₘ.

### Alternative Embodiment

When a correlation between the elements of the matrix Bⱼ is high because the observing time is short, for example, the correlation matrix Rxxⱼ may be subjected to averaging. For example, averaging, such as forward-backward averaging and spatial moving average, may be applied to the correlation matrix Rxxⱼ. These processes may be applied solely or in combination.

A specific example of a method of calculating a forward-backward average for a correlation matrix Ru is shown by the mathematical expression (6). Note that r* denotes a complex conjugate of r.

$$Ru = ( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) ⇒ Rus ( \begin{matrix}{r}_{11} + {r}_{33}^{*} & {r}_{12} + {r}_{32}^{*} & {r}_{13} + {r}_{31}^{*} \\ {r}_{21} + {r}_{23}^{*} & {r}_{22} + {r}_{22}^{*} & {r}_{23} + {r}_{23}^{*} \\ {r}_{31} + {r}_{13}^{*} & {r}_{32} + {r}_{12}^{*} & {r}_{33} + {r}_{11}^{*}\end{matrix} ) \qquad ( 6 )$$

In addition, in the moving average, a plurality of sub-arrays are defined along a diagonal line of the correlation matrix Rxxⱼ, and then those components are averaged to calculate a new matrix. A specific example of the moving average for the correlation matrix Ru is shown by the mathematical expression (7).

$$Ru = ( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) ⇒ Rus ( \begin{matrix}{r}_{11} + {r}_{22} & {r}_{12} + {r}_{23} \\ {r}_{21} + {r}_{32} & {r}_{22} + {r}_{33}\end{matrix} ) \qquad ( 7 )$$

Here, a sub-array 1 S₁ and a sub-array 2 S₂ are respectively defined as follows.

$${S}_{1} = ( \begin{matrix}{r}_{11} & {r}_{12} \\ {r}_{21} & {r}_{22}\end{matrix} ) {S}_{2} = ( \begin{matrix}{r}_{22} & {r}_{23} \\ {r}_{32} & {r}_{33}\end{matrix} )$$

The thus obtained new correlation matrix Rus is utilized to estimate information about each target 200. A high-resolution estimation method, such as the MUSIC method, the ESPIRIT method and the Capon method, may be desirably employed for estimation.

What is claimed is:

1. A radar system comprising:
a transmission antenna that outputs transmission signals having a plurality of frequencies as transmission waves;
a plurality of reception antennas that receive reflected waves of the transmission signals, reflected from an object;
a mixer that mixes the transmission signals with reception signals received by the reception antennas to generate beat signals of the reception signals received by the respective reception antennas for each of the transmission signals; and
a signal processing unit that detects Doppler frequency by analyzing frequencies of the beat signals, that detects phase information of the Doppler frequency for each of combinations of the reception antennas and the frequencies of the transmission signals, that constructs a matrix, in which the pieces of phase information are arranged in a predetermined order with respect to the reception antennas and the frequencies of the transmission signals, that obtains a correlation matrix from the matrix and a complex conjugate transposed matrix of the matrix, and that estimates at least one of a distance to the object, a direction to the object and a relative velocity of the object on the basis of the correlation matrix.

2. The radar system according to claim 1, wherein the signal processing unit averages the correlation matrix by at least one of forward-backward averaging and spatial moving average, to obtain a averaged correlation matrix, and estimates the at least one of the distance to the object, the direction to the object and the relative velocity of the object on the basis of the averaged correlation matrix.

3. The radar system according to claim 1, wherein if a plurality of the Doppler frequencies are detected, the signal processing unit constructs the matrix for each of the Doppler frequencies, obtains the correlation matrix corresponding to each matrix, and estimates the at least one of the distance to the object, the direction to the object and the relative velocity of the object for each correlation matrix.

4. The radar system according to claim 1, wherein the Doppler frequency is generated on the basis of the relative velocity of the object.

5. The radar system according to claim 1, wherein each beat signal is a signal that have a frequency corresponding to a difference between a frequency of the transmission signal and a frequency of the reception signal.

6. The radar system according to claim 1, wherein each piece of phase information of the Doppler frequency is a complex signal component of the Doppler frequency in a frequency spectrum of a corresponding one of the beat signals.

7. A signal processing method for a radar system that includes a transmission antenna that outputs transmission signals having a plurality of frequencies as transmission waves and a plurality of reception antennas that receive reflected waves of the transmission signals, reflected from an object, the signal processing method comprising:
mixing the transmission signals with reception signals received by the reception antennas to generate beat signals of the reception signals received by the respective reception antennas for each of the transmission signals having the plurality of frequencies;
detecting Doppler frequency by analyzing frequencies of the beat signals;
detecting phase information of the Doppler frequency for each of combinations of the reception antennas and the frequencies of the transmission signals;
constructing a matrix, in which the pieces of phase information are arranged in a predetermined order with respect to the reception antennas and the frequencies of the transmission signals;
obtaining a correlation matrix from the matrix and a complex conjugate transposed matrix of the matrix; and
estimating at least one of a distance to the object, a direction to the object and a relative velocity of the object on the basis of the correlation matrix.
